(19) United States
(12) Patent Application Publication
(10) Pub. No.: US 2024/0382996 A1
(43) Pub. Date: Nov. 21, 2024

(54) ANTI RUN-OVER SPRINKLER DEVICE

(71) Applicant: Joaquin Garza Muguerza, San Antonio, TX (US)

(72) Inventor: Joaquin Garza Muguerza, San Antonio, TX (US)

(21) Appl. No.: 18/770,740

(22) Filed: Jul. 12, 2024

Related U.S. Application Data
(63) Continuation-in-part of application No. 17/216,682, filed on Mar. 30, 2021.

(51) Int. Cl. B05B 15/656; B05B 15/18

(52) U.S. Cl. CPC B05B 15/656; B05B 15/18

(57) ABSTRACT

An anti run-over (ARO) sprinkler device including a housing, sprinkler region and a run-over region. The sprinkler region includes a piston, first cap, first seal and a primary spring. The run-over region includes a second cap, second seal, secondary spring and a water inlet. The device operates to prevent damage to the device when unintentional force is applied thereto. The device includes a secondary spring which contracts when unintentional force is applied to the device to prevent damage to the device. The secondary spring is configured to operate in either a compressed state where coils of the secondary spring are compressed together thereby causing the piston to push downwards into the second cavity of the housing when pressure is applied to the top of the sprinkler region or in an expanded state where the coils of the secondary spring are extended away from one another thereby causing the sprinkler region to push outward and away from the second cavity when the pressure applied to the top of the sprinkler region ceases.

### CROSS REFERENCE TO RELATED APPLICATION

This application is a continuation-in-part of pending U.S. Non-Provisional application Ser. No. 17/216,682 filed on Mar. 30, 2021, the disclosure of which is incorporated herein by reference in its entirety.

### FIELD OF THE INVENTION

Embodiments described herein generally relate to a sprinkler device, and more particularly to an anti run-over sprinkler device.

### BACKGROUND OF THE INVENTION

Sprinklers have the tendency to easily get damaged when a person kicks it with their feet or when it gets run over by a vehicle. Further, a person at times does not have control of how or when their sprinkler systems get destroyed. As a result of the weak tubing parts, constant changing of the sprinkler device may be necessary and costly. Hence, an improved sprinkler that provides an individual with retractable mechanism that is sustainable to damage of any kind is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of an anti run-over sprinkler device in a default position according to an embodiment of the present disclosure.

FIG. 2 shows an exemplary view of the anti run-over device in a first mode of operation according to an embodiment of the present disclosure,

FIG. 3 shows an exemplary view of the anti run-over device in a second mode of operation according to an embodiment of the present disclosure.

### SUMMARY OF THE INVENTION

Exemplary embodiments disclosed herein describe an anti run-over (ARO) sprinkler device including a housing, piston region, body region, piston, first cap, first seal, primary spring, second cap, second seal, secondary spring and water inlet. The housing includes a primary housing and a secondary housing. The primary housing includes a first cavity for enclosing a piston and a primary spring and the secondary housing includes a second cavity for storing a secondary spring and a water inlet. The piston includes a nozzle and a riser stem, wherein the nozzle is attached to a proximate end of the riser stem. The first cap is attached to a proximate end of the primary housing, the first cap enclosing a first seal which is configured to prevent water from leaking from the proximate end of the primary housing. The primary spring encloses the riser stem and is configured to actuate vertical motion of the piston within the first cavity of the housing, the primary spring is configured to operate in either a compressed state where a plurality of coils of the primary spring are compressed together thereby causing the piston to move in an upward direction through the first cavity when water pressure is applied to the first cavity through the secondary cavity or an expanded state where the plurality of coils of the primary spring are extended away from one another thereby causing the piston to move in a downward direction back into the bottom of the first cavity when the pressure applied to the first cavity ceases. The second cap is attached to a proximate end of the secondary housing, the second cap enclosing a second seal which is configured to prevent water from leaking from the proximate end of the secondary housing. The secondary spring is enclosed within the secondary housing below the first cavity, the secondary spring is configured to operate in either a compressed state where a plurality of coils of the secondary spring are compressed together thereby causing the piston to move in a downward direction into the second cavity of the secondary housing when external pressure or force is applied to the top of the sprinkler device or in an expanded state where the plurality of coils of the secondary spring are extended away from one another thereby causing the piston to move in an upward direction back into the bottom of the first cavity when the pressure or force applied to the second cavity ceases.

Exemplary embodiments disclosed herein describe an anti run-over (ARO) sprinkler device having a unified structure including a sprinkler region and a run-over region. The sprinkler region having a unified sub-assembly including a primary housing, a first cavity, a piston, wherein the first cavity encloses the piston. Further, the piston includes a nozzle, a riser stem, and a primary spring, and the nozzle is attached to a proximate end of the riser stem, and the riser stem is enclosed in the primary spring. The run-over region has a unified sub-assembly including a secondary housing, a second cavity, a secondary spring, and a water inlet. The primary spring is configured to actuate vertical motion of the piston within the first cavity of the primary housing in a first mode of operation, the primary spring includes a plurality of coils, and the plurality of coils are in an expanded form when the device is operating in a default state, and the plurality of coils are compressed together when the device transitions to a first mode of operation from the default state. The secondary spring is enclosed within the secondary housing below the first cavity and is configured to actuate vertical motion of at least a part of the sprinkler region, as a unified sub-assembly, within the second cavity in a second mode of operation, the secondary spring includes a plurality of coils, and the plurality of coils are in an expanded form when the device is operating in a default state, and the plurality of coils are compressed together when the device transitions to a second mode of operation from the default state or the first mode of operation.

In some embodiments, the first mode of operation is triggered when pressure is received in the first cavity from the water inlet.

In some embodiments, the pressure from the water inlet causes the plurality of coils of the primary spring to compress.

In some embodiments, the plurality of coils of the primary spring are expanded when the pressure from the water inlet stops.

In some embodiments, the second mode of operation is triggered when pressure is received in the second cavity from the sprinkler region.

In some embodiments, the sprinkler region causes pressure on the secondary spring when downward pressure is received at a proximate end of the device.

In some embodiments, the pressure causes the plurality of coils of the second spring to compress.

In some embodiments, the plurality of coils of the secondary spring are expanded when the pressure ceases.

In some embodiments, the sprinkler region includes a pair of distal piston stoppers, and the distal piston stoppers prevent the sprinkler region from descending out of the run-over region.

In some embodiments, the sprinkler region and the run-over region share an overlapping region.

In some embodiments, the primary spring is a cylindrical retraction spring.

In some embodiments, the secondary spring is a cylindrical retractable spring.

### DETAILED DESCRIPTION

The present disclosure relates to an anti run-over sprinkler device (“device”) 10 designed to prevent damage to the device when it is stepped on or run over. The design of the device includes a lower structure (i.e., run-over region 21) at its distal end 47, which is configured to enclose at least part of the top region (i.e., sprinkler region 13) of the device by means of a spring mechanism which is compressed when the proximal end 45 of the device is stepped on or run-over. In contrast, conventional sprinkler devices are prone to damage when stepped on or run-over because they lack structure(s) to counteract the corresponding applied force, thereby leading the device to crack or break.

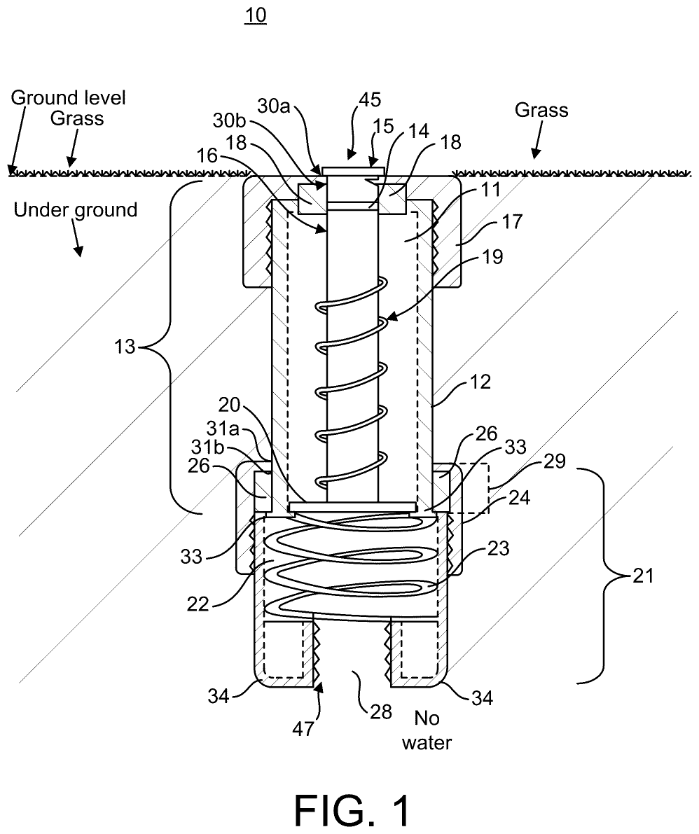

Further, the device 10 is configured to be installed underground, as shown in FIGS. 1-3, and the device has three modes of operation including a default mode, a first mode, and a second mode. The device is configured to operate in one mode at a time. In the default mode, the movable parts of the device 10 are stationary, as shown in FIG. 1. The movable parts remain stationary until pressure or force is applied to either the distal end 47 of the device (e.g., water pressure) thereby triggering the first mode of operation (i.e., transitioning the device from the default mode to the first mode of operation), or to the proximal end 45 of the device (e.g., force from someone stepping on the device or a car/bike/object running over the device), thereby triggering the second mode of operation (i.e., transitioning the device from the default mode to the second mode of operation). In some embodiments, the second mode of operation may transition from the first mode of operation.

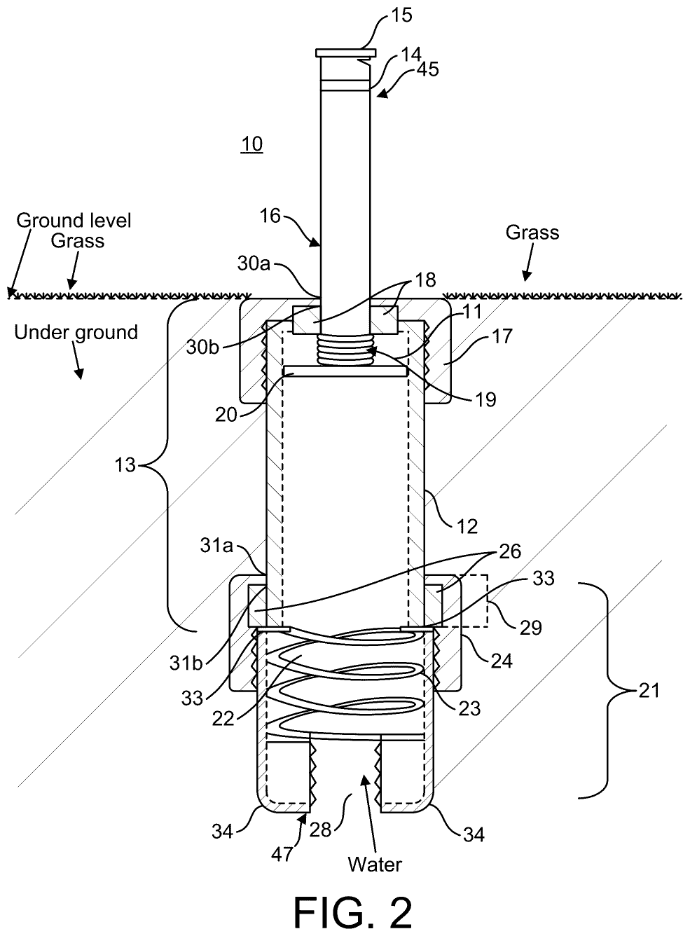

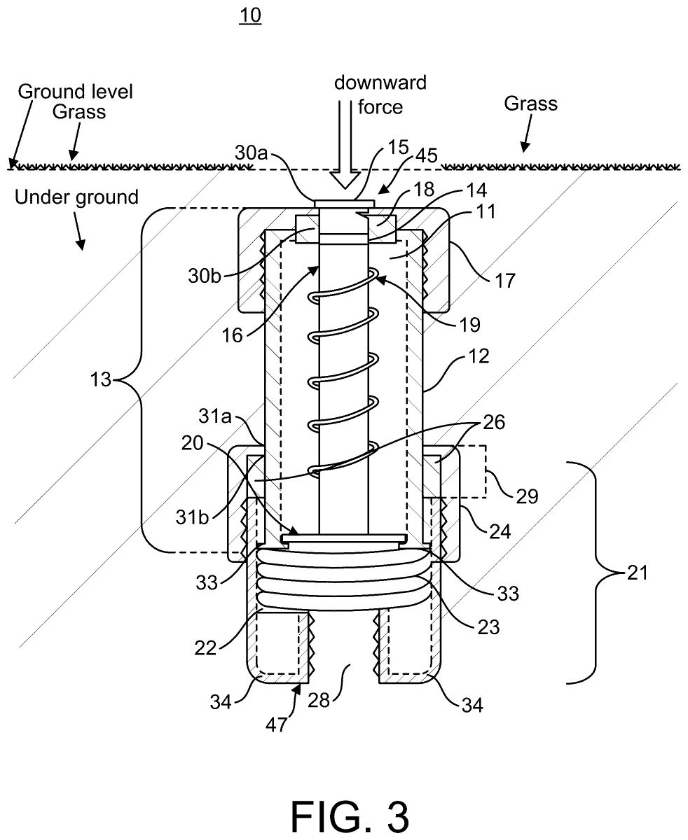

In the first mode of operation, at least one movable part of the device rises above the ground level when pressure is applied at the distal end of the device, as shown in FIG. 2, and descends back underground when the pressure stops into a position shown in FIG. 1. In the second mode of operation, at least one movable part of the device descends into second cavity 22 of the run-over region 21 of the device when pressure is applied at the proximate end of the device, as illustrated in FIG. 3, and the at least one movable part returns to its prior position when the pressure stops.

Turning to FIG. 1, the anti run-over sprinkler device (“the device”) 10 includes a primary housing 12, a first cavity 11, a riser stem 14, a piston 16, a first cap 17, a first seal 18, a primary spring 19, a proximate piston stopper 20, distal piston stopper(s) 33, a secondary housing 34, a second cavity 22, a secondary spring 23, a second cap 24, a second seal 26 and a water inlet 28. The primary housing 12 and the secondary housing 34 may be constructed of any suitable material, such as, for example, plastic.

The device 10 is constructed as a unified structure comprising two sub-parts (i.e., a sprinkler region 13 and a run-over region 21), where at least part of the sprinkler region is enclosed within the run-over region. Each sub-part includes a sub-assembly of one or more parts, and each sub-part includes at least one movable part.

Moreover, the sprinkler region 13, as a unified subassembly, is movable relative to the run-over region 21 in the second mode of operation, as discussed further below.

The sprinkler region 13 includes primary housing 12, first cavity 11, piston 16, first cap 17, first seal 18, and distal piston stopper(s) 33, which all form a unified sub-assembly. Piston 16 is enclosed within first cavity 11 and is a movable part within the sprinkler region. Movement of the piston is triggered by its primary spring 19 which responds to water pressure received from incoming water flow at water inlet 28 as discussed further below.

The run-over region 21 includes secondary housing 34, secondary spring 23, second cavity 22, second cap 24, second seal 26 and water inlet 28. The second cavity encloses secondary spring 23. The second cavity 22, secondary spring 23 and water inlet 28 are enclosed within secondary housing 34. The secondary spring is positioned directly underneath the sprinkler region 13. The sprinkler region 13 and the run-over region 21 share an overlapping region 29. The secondary spring is a movable part within the run-over region and its movement is triggered by pressure received from downward movement of the sprinkler region which occurs when downward pressure (e.g., when the device is stepped on or run-over) is applied to the proximate end of the device (i.e., the top of the sprinkler region).

Referring back to the sprinkler region 13, the first cap 17 is attached to a proximate end of the primary housing 12 and is configured to secure the nozzle 15 to the riser stem 14. The first cap 17 encloses first seal 18, and the first seal may be made of plastic and is configured to seal the riser stem 14 so that water leakage does not occur at the proximate end of the primary housing 12 (i.e., where the first cap attaches to the housing). The first cap 17 and the first seal 18 both include an aperture (30a, 30b, respectively) through which the piston (i.e., riser stem 14) moves upwards and downwards. Piston 16 includes nozzle 15, riser stem 14, primary spring 19 and proximate piston stopper 20. Primary spring 19 encloses riser stem 14 which has nozzle 15 attached thereto at its proximate end. The nozzle includes one or more openings for releasing water when water pressure is received from water flow at water inlet 28.

The primary spring 19 is configured to actuate upward or downward vertical motion of the piston within the first cavity 11 of the primary housing 12 based upon pressure received from water inlet 28. The primary spring may include a cylindrical retraction spring which includes a plurality of coils that are configured to operate in either an expanded state (i.e., the default state of the plurality of coils) or a compressed state. In the expanded state, the plurality of coils are extended away from one another. In a compressed state, the plurality of coils are compressed together. The riser stem 14 may be enclosed within the plurality of coils of the primary spring. The primary spring may be activated automatically when pressure (force) is applied to the first cavity 11 or the primary spring 19. The force applied to the first cavity 11 or the primary spring 19 may be exerted from water pressure which is applied to the first cavity when water enters water inlet 28 and travels upstream through the first cavity 11.

In the default mode of operation, the piston 16 is positioned underground with its primary spring 19 in an expanded position and proximate piston stopper 20 resting on distal piston stoppers 33. Each distal piston stopper 33 is positioned directly below second seal 26 and directly above secondary spring 23, as shown in FIG. 1, and prevents the piston from entering the run-over region in the default or first mode of operation. In the first mode of operation, the riser stem 14 moves up and down in the first cavity 11 consistent with the operations of primary spring 19 which causes the nozzle and at least part of the riser stem to raise above the surrounding grass blades or crops for watering when water pressure occurs (i.e., water flows through water inlet 28) and which causes the nozzle and at least a part of the riser stem to lower or descend back into first cavity 11 when the water pressure stops. The proximate piston stopper 20 prevents the riser stem 14 from ascending out of the primary housing 12 when the device is operating in the first mode. The piston ascends upward from the first cavity 11 when the device is operating (i.e., activated to release water from the nozzle) and then descends back below ground when not in use. The distal piston stoppers 33 remain in their position in the first mode of operation. In the second mode of operation, the entire sprinkler region is configured to move downward (i.e., descend) into cavity 22 in the run-over region and this movement is triggered by a downward force at the proximate end of the device which activates secondary spring 23. The distal piston stoppers 33 are positioned within secondary cavity 22 during the second mode of operation and prevent the sprinkler region 13 from descending out of the run-over region 21 during the second mode of operation.

Referring back to the run-over region 21, the second cap 24 is attached to a proximate end of the secondary housing 34 where the first cavity 11 and the second cavity 22 abut one another. The second cap is configured to secure the sprinkler region 13 to the run-over region 21. The second cap 24 encloses second seal 26. The second seal may be made of plastic and is configured to seal the portion of the piston region which extends into the run-over region 21 (i.e., overlapping region 29) so that water leakage does not occur at the proximate end of the secondary housing 34 (i.e., where the second cap attaches to the secondary housing). Since the second cavity 22 is wider than the first cavity 11, water may be prone to leak where the first cavity abuts the second cavity; thus, the second seal operates to prevent water leakage in that area. The second cap 24 and the second seal 26 both include an aperture (31a, 31b, respectively) for enclosing the portion (i.e., region 29) of the sprinkler region 13 which extends into the run-over region 21, and through which at least a part of the sprinkler region, as a unified subassembly, moves upwards and downwards.

The secondary spring 23 is enclosed within the secondary housing 34 directly below the first cavity 11. The secondary spring is configured to actuate upward and downward vertical motion of the sprinkler region 13 within the second cavity 22 of the secondary housing 34. The secondary spring may include a cylindrical retraction spring which includes a plurality of coils that are configured to operate in either an expanded state (i.e., the default state of the plurality of coils) or a compressed state. In an expanded state, the plurality of coils are extended away from one another. In a compressed state, the plurality of coils are compressed together.

The secondary spring 23 may be activated automatically when force is applied to the second cavity 22. The force applied to the second cavity 22 may be exerted from pressure applied to nozzle 15 and/or first cap 17 while the primary spring is in an expanded state (which occurs when the device 10 is not releasing water from the nozzle 15). Pressure may be applied to the nozzle 15 and/or first cap 17 when, for example, an entity (e.g., an individual, an animal, etc.) steps on the nozzle. Moreover, pressure may be applied to the nozzle and/or first cap 17 when, for example, an automobile, lawn mower, bike or any other moving device with wheels runs over the nozzle and/or first cap 17.

In the default and first mode of operation, the run-over region is stationary as shown in FIGS. 1 and 2. In a second mode of operation, the plurality of coils of the secondary spring 23 are compressed, when force is applied to the second cavity, thereby causing at least a part of the sprinkler region 13 to move in a downward direction into the second cavity 22. When the force applied to the second cavity ceases, the plurality of coils of the secondary spring expand, thereby causing at least part of the sprinkler region to move in an upward direction back into the first cavity 11.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An anti run-over (ARO) sprinkler device comprising:
a unified structure including a sprinkler region and a run-over region;
the sprinkler region having a unified sub-assembly including a primary housing, a first cavity, a piston, wherein the first cavity encloses the piston;
the piston including a nozzle, a riser stem, and a primary spring, wherein the nozzle is attached to a proximate end of the riser stem, and the riser stem is enclosed in the primary spring;
the run-over region having a unified sub-assembly including a secondary housing, a second cavity, a secondary spring, and a water inlet;
the primary spring is configured to actuate vertical motion of the piston within the first cavity of the primary housing in a first mode of operation, the primary spring includes a plurality of coils, and the plurality of coils are in an expanded form when the device is operating in a default state, and the plurality of coils are compressed together when the device transitions to a first mode of operation from the default state;
the secondary spring is enclosed within the secondary housing below the first cavity, the secondary spring is configured to actuate vertical motion of at least a part of the sprinkler region, as a unified sub-assembly, within the second cavity in a second mode of operation, the secondary spring includes a plurality of coils, and the plurality of coils are in an expanded form when the device is operating in a default state, and the plurality of coils are compressed together when the device transitions to a second mode of operation from the default state or the first mode of operation.

2. The device of claim 1 wherein the first mode of operation is triggered when pressure is received in the first cavity from the water inlet.

3. The device of claim 2 wherein the pressure from the water inlet causes the plurality of coils of the primary spring to compress.

4. The device of claim 3 wherein the plurality of coils of the primary spring are expanded when the pressure from the water inlet stops.

5. The device of claim 1 wherein the second mode of operation is triggered when pressure is received in the second cavity from the sprinkler region.

6. The device of claim 5 wherein the sprinkler region causes pressure on the secondary spring when downward pressure is received at a proximate end of the device.

7. The device of claim 5 wherein the pressure causes the plurality of coils of the second spring to compress.

8. The device of claim 7 wherein the plurality of coils of the secondary spring are expanded when the pressure ceases.

9. The device of claim 1 wherein the sprinkler region includes a pair of distal piston stoppers, and the distal piston stoppers prevent the sprinkler region from descending out of the run-over region.

10. The device of claim 1, wherein the sprinkler region and the run-over region share an overlapping region.

11. The device of claim 1, wherein the primary spring is a cylindrical retraction spring.

12. The device of claim 1, wherein the secondary spring is a cylindrical retractable spring.
